(19) United States
(12) Patent Application Publication
(10) Pub. No.: US 2011/0256415 A1
(43) Pub. Date: Oct. 20, 2011

(54) Polypropylene Anti-Static Membrane

(76) Inventor: Chien-Chang TSENG, Ta-Yuan Hsiang (TW)

(21) Appl. No.: 12/360,160

(22) Filed: Jan. 27, 2009

(51) Int. Cl. B32B 27/00

(52) U.S. Cl. 428/500

(57) ABSTRACT

A polypropylene anti-static membrane includes a PP (Polypropylene) board, which contains an anti-static agent to prevent from statics, and at least one surface of which is a cloudy surface. When the PP board is used as a base plate for cutting an optical material, such as a polarizer, tool marks that are left on a surface, while severing, can be restored, due to that the PP material is very firm and extremely flexible; therefore, fiber wires and powder will not be produced easily when the optical material is severed repeatedly. On the other hand, as the PP material is very firm and shock-proof, the optical material does not fracture easily and can be used longer. In addition, a probability that a surface of the optical product is damaged by pressing and scratching can be reduced.

### BACKGROUND OF THE INVENTION

a) Field of the Invention The present invention relates to a polypropylene anti-static membrane, and more particularly to a polypropylene anti-static membrane which contains an anti-static agent, is robust, is shock-proof, does not produce fiber wires and powder easily and can reduce a probability that a surface of a product is damaged by pressing and scratching, while being used as a base plate for cutting an optical material, such as a polarizer.

b) Description of the Prior Art

As plastic is tightly related to a daily life of people, how to satisfy people's needs, improve features of usage and reduce production cost, are all issues that should be concerned by manufacturers. Accordingly, a study of synthesizing theory and technology has been prevailing by the plastic industry to create new products by using the synthesizing technology, based on the features of all kinds of different plastic materials, thereby enabling the plastic industry to quickly become a promising chemical industry.

Most of the ordinary and conventional base plates that are used for cutting the optical material, such as the polarizer, are made by a PET (Polyethylene Terephthalate) membrane, as shown in FIG. 1. In operation, an optical material 11, such as a polarizer, is transported to a lower side of a cutter 12 by a transporting device of a cutting machine; whereas, a PET membrane 13 is also transported exactly to a lower side of the optical material 11, such as the polarizer, by the transporting device of the cutting machine, such that the optical material 11, such as the polarizer, can be severed into a plurality of optical products of a default size, by an anvil block function of the PET membrane 13.

However, as the conventional PET membrane is harder and not flexible, tool marks that are left on a surface while severing will be opened and cannot be restored. Thus, fiber wires and powder will be produced when the PET membrane is severed repeatedly, which causes a surface of the optical product to be damaged by pressing and scratching, and allows the optical product to be deformed and broken easily after a long time of usage, thereby being very inconvenient.

### SUMMARY OF THE INVENTION

The primary object of the present invention is to provide a polypropylene anti-static membrane which contains an anti-static agent, is robust, is shock-proof, does not produce fiber wires and powder easily and can reduce a probability that a surface of a product is damaged by pressing and scratching, while being used as a base plate for cutting an optical material, such as a polarizer.

Accordingly, the polypropylene anti-static membrane of the present invention is provided with a PP (polypropylene) board which contains an anti-static agent to prevent from statics and at least one surface of which is a cloudy surface. In using, an optical material, such as a polarizer, is transported to a lower side of a cutter by a transporting device of a cutting machine; whereas, a belt of PP board is also transported exactly to a lower side of the optical material, such as the polarizer, by the transporting device of the cutting machine, such that the optical material, such as the polarizer, can be severed into a plurality of optical products of a default size, by an anvil block function of the PP board. Accordingly, tool marks that are left on a surface, while severing, can be restored by that the PP material is provided with good firmness and is extremely flexible; therefore, the fiber wires and powder will not be produced easily when the optical material is severed repeatedly. In addition, the probability that the surface of the optical product is damaged by pressing and scratching can be reduced, as the PP material does not fracture easily and can be used longer, due to that the PP material is very firm and shock-proof.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of usage of a conventional PET membrane.

FIG. 2 shows a plan view of a PP anti-static membrane of the present invention.

FIG. 3 shows a schematic view of use of a PP anti-static membrane of the present invention.

FIG. 4 shows an enlarged view of use of a PP anti-static membrane of the present invention.

FIG. 5 shows another enlarged view of use of a PP anti-static membrane of the present invention.

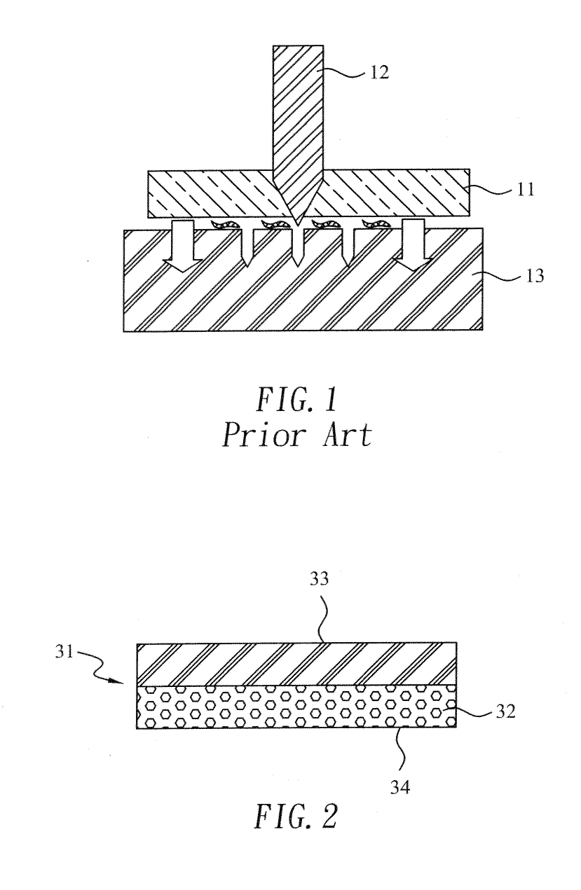

### DETAILED DESCRIPTION OF THE PREFERRED EMBODIMENTS

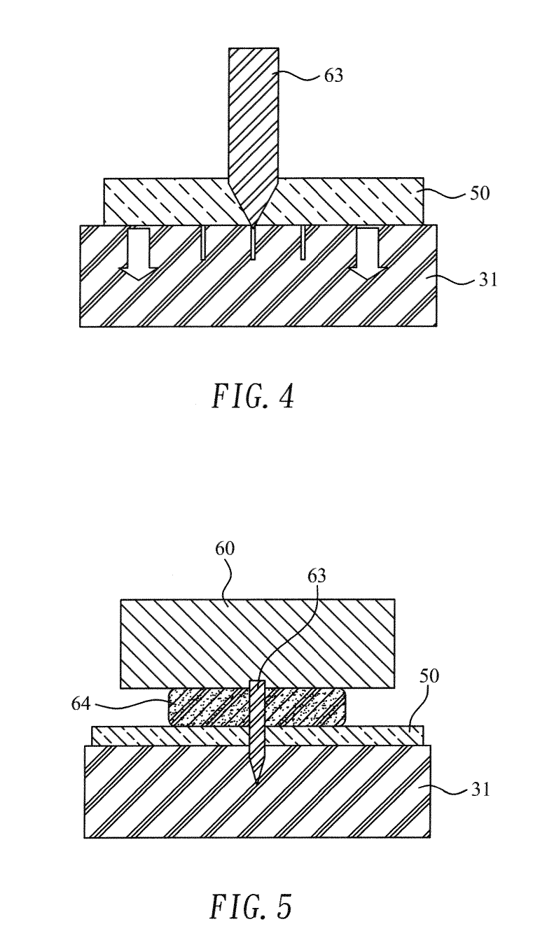

Referring to FIG. 2 and FIG. 4, a polypropylene anti-static membrane of the present invention comprises a PP board 31 which is provided with an anti-static agent 32 to prevent from statics, and at least one surface of which is a cloudy surface 34.

As shown in FIG. 4, in using, when the PP board 31 is used as a base plate for cutting an optical material 50 (such as an optical membrane, a polarizer, a brightness enhancement film or a retardation film), tool marks that are left on a surface, while severing, can be restored by that the PP material is very firm and extremely flexible; therefore, fiber wires and powder will not be produced easily, when the optical material 50 is severed repeatedly. Furthermore, as the PP material is very firm and shock-proof, the optical material 50 does not fracture easily and can be used longer; therefore, a probability that a surface of an optical product is damaged by pressing and scratching can be reduced.

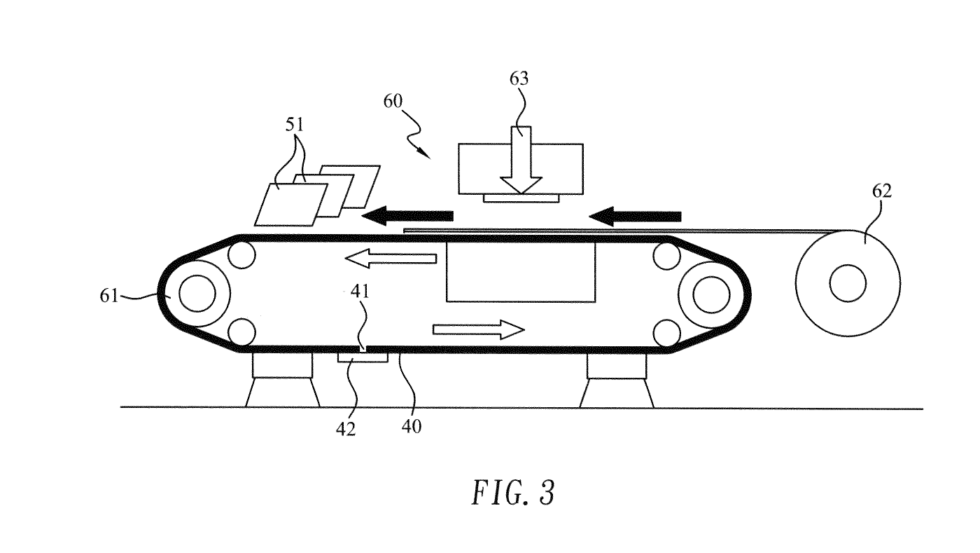

Referring to FIG. 3 and FIG. 4, when the PP anti-static membrane of the present invention is used as the base plate for cutting the optical material 50, such as the polarizer, a loop-shape belt of board 40 is formed by the continuous boards 31, with an opening 41 of the belt of board 40 being attached by a chosen tape 42. The belt of board 40 is sheathed on a transporting device 61 of a cutting machine 60 to rotate along with the transporting device 61. On the other hand, a raw material of the optical material 50, such as the polarizer, is a roll of optical material belt 62 which is also transmitted to a lower side of a cutter 63 by the transporting device 61.

In operation, the optical material 50, such as the polarizer, is transported to a lower side of the cutter 63 by the transporting device 61 of the cutting machine 60, whereas the belt of board 40 that is formed by the boards 31 is also transported exactly to a lower side of the optical material 50 by the transporting device 61 of the cutting machine 60, such that by an anvil block function of the board 31, the optical material 50, such as the polarizer, can be severed into a plurality of optical products 51 of a default size.

Referring to FIG. 5, it shows another embodiment of the present invention, wherein an elastic buffer pad 64 (such as a sponge pad or a foam pad) is provided between the cutter 63 of the cutting machine 60 and the optical material 50, such as the polarizer. By elasticity of the elastic buffer pad 64, severing force of the cutter 63 is buffered, so as to prevent from too large the severing force that a surface of the optical material 50, such as the polarizer, is damaged.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A polypropylene anti-static membrane comprising a PP (Polypropylene) board, wherein the PP board contains an anti-static agent to prevent from statics and at least one surface of the board is a cloudy surface, such that when the PP board is used as a base plate for cutting an optical material, a polarizer, tool marks that are left on a surface, while severing, are restored that fiber wires and powder will not be produced easily when the optical material is severed repeatedly, due to that the PP material is very firm and extremely flexible; in addition, as the PP material is very firm and shock-proof, the optical material not fracturing easily, being used longer, and a probability that a surface of the optical product being damaged by pressing and scratching being reduced.

2. The polypropylene anti-static membrane according to claim 1, wherein the optical material includes an optical membrane, a polarizer, a brightness enhancement film or a retardation film.
